(19) United States
(12) Patent Application Publication
(10) Pub. No.: US 2024/0232989 A1
(43) Pub. Date: Jul. 11, 2024

(54) Pre-Sales Interface Cockpit

(71) Applicant: Arnd Dixit, Berlin (GE)

(72) Inventor: Arnd Dixit, Berlin (GE)

(21) Appl. No.: 17/301,165

(22) Filed: Mar. 29, 2021

Related U.S. Application Data
(60) Provisional application No. 63/121,877, filed on Dec. 5, 2020.

(51) Int. Cl. G06Q 30/0601; H04L 67/565

(52) U.S. Cl. CPC G06Q 30/0635; H04L 67/565

(57) ABSTRACT

The current invention relates to a pre-sales interface cockpit software that lets businesses and organizations have access to an all-inclusive dashboard where Business/IT logic is centralized within SAP for sales order processing. Large orders can be placed, monitored, and corrected through one interface/system. This eliminates the need to connect to many intermediary systems for formatting the data for readability. Furthermore, sales orders can be created using input data such as EDIFACT, XML, Excel, Mass Order Create, Quick Order Entry, PDF upload, CSV, among others.

### FIELD OF INVENTION

In general, the present invention relates to systems applications and products (SAP), which help businesses and organizations manage and process large quantities of data. More specifically, the invention relates to a pre-sales interface cockpit.

### RELATED APPLICATIONS

US20140156343A1: A system and method for multi-tier channel partner management for recurring revenue sales are disclosed. A plurality of tiers related to a recurring revenue asset is designated. Each tier of the plurality of tiers having a set of permissions and rules, the permissions of the tier enabling a user associated with the tier to access information in a database about the recurring revenue asset, and the rules defining permitted interactions between the user and the recurring revenue management system with respect to the recurring revenue asset. Data representing one of the plurality of tiers is received relating to the recurring revenue asset and associated with the user. Data relating to the recurring revenue asset is transmitted. The transmitted data is permitted to be sent to the user based on the tier associated with the user and the recurring revenue asset. A permitted interaction for the user is then executed with the recurring revenue management system to manage the recurring revenue asset.

US20130346136A1: A method, a system, and computer-readable medium for processing of data are disclosed. At least one customer requirement concerning at least one business process and at least one customer requirement concerning at least one non-business process related activity are determined. A mapping of determined customer requirements to at least one available service is generated. Mapped customer requirements and available services are mapped into a project. A pricing for the project is generated.

### BACKGROUND OF THE INVENTION

SAP (Systems Applications and Products) helps businesses and organizations manage and process large quantities of data. In particular, sales order processing is an E2E process that requires efficient automated tools to manage effectively without requiring large quantities of person-hours.

One main challenge encountered while using SAP's is that sales order processing business logic is typically distributed through many satellite systems and legacy landscapes. Companies often need to download files and upload files using multiple servers, sometimes requiring middleware or a converter. Each additional system or step in the process can introduce inefficiencies. In a business or organization that processes large quantities of data, small inefficiencies quickly become magnified and equate to loss of profits and person-hours.

Subsequently, there is a need on the market for a tool that allows the placement of large orders without having the complexity of having to connect to many intermediary systems for formatting the data to required formats.

Furthermore, the SAP standard functionality does not have a single dashboard where you can monitor sales orders or upload data encoded in different formats such as Excel upload, PDF upload, EDIFACT upload, RFC, Proxy, CSV, XML upload, IDOC monitoring (error analysis, issue resolution and solution) for the end Business users. Overly, such systems provide a transactional interface for IT that is both complex, unsynchronized and generally not suitable for the end users who are business oriented.

The focus of this disclosure is the provision of pre-sales cockpit relating to systems applications and products (SAP), which help businesses and organizations manage and process large quantities of data efficiently, and reduce the technicality associated with such systems.

### SUMMARY OF THE INVENTION

The following summary is an explanation of some of the general inventive steps for the electric system, method, cockpit and other elements of the description. This summary is not an extensive overview of the invention and does not intend to limit the scope beyond what is described and claimed as a summary.

The current invention is a pre-sales interface cockpit software that lets businesses and organizations have access to an all-inclusive dashboard where Business/IT logic is centralized within SAP for sales order processing. Large orders can be placed, monitored, and corrected through one interface/system. This eliminates the need to connect to many intermediary systems for formatting the data for readability. Furthermore, sales orders can be created using input data such as EDIFACT, XML, Excel Upload, Mass Order Create, Quick Order Entry, PDF upload, CSV, among others.

Features of the current inventions may be further configured for maximum utility in that the cockpit processes can be automated to run in the background without manual intervention from a user, and exceptions can be handled in said automated state. Generally, the solution presented by the current invention requires to be adapted to the Business requirements of the specific business or organization, which are first gathered specifically, tested, and implemented for highest quality results. Additionally, the features of the current invention can also be provided in raw form without having to be adapted to the customers needs, allowing the flexibility for a the user to decide how they would like to implement it in their specific SAP ERP/S4 landscape.

In an embodiment, data entered into the system via the cockpit is presented and managed as business data. The system automatically manages common daily business tasks, staff only need to review and manage exceptions and analyze the contents. Data can be automatically or manually created, and can be checked prior to becoming a sales order. The pre-sales interface cockpit software integrates with other business applications and software. It parks orders before actual processing, and increases the visibility of errors while providing a range of solutions. Sales orders can be monitored via IDOCs (Intermediate Documents). It gives more flexibility and scalability to the end users to change data before an actual order is created in the system.

### BRIEF DESCRIPTION OF THE FIGURES

FIG. 1 is an illustrative representation of a pre-sales interface cockpit, showing the flow of data from customer/legacy systems through to order creation, as a system diagram, in accordance with an embodiment of the present invention.

FIG. 2 is an illustrative representation of the two variations of the cockpit's functionality. The variation 1 represents manual/background processing of files in different formats as described, while the variation 2 represents formats/protocols used by the cockpit to process the messages inside of the cockpit

FIG. 3 is an illustrative representation of a process performed in a pre-sales interface cockpit, showing the steps from sales data input through to sales order creation, as a system diagram, in accordance with an embodiment of the present invention.

FIG. 4 is an illustrative representation of a process performed in a pre-sales interface cockpit, showing the levels at which sales order validation rules can be applied, as a system diagram, in accordance with embodiments of the present invention.

FIG. 5 is an illustrative representation of a process performed in a pre-sales interface cockpit, showing the levels at which posting rules can be applied, as a system diagram, in accordance with an embodiment of the present invention;

FIG. 6 is an illustrative representation of a process performed in a pre-sales interface cockpit, including the pre-sales activity cockpit screen/interface, in accordance with an embodiment of the present invention.

FIG. 7 is an illustrative representation of a process performed in a pre-sales interface cockpit, including the edit/response/action that can be taken by the system upon failure of a validation, as a system diagram, in accordance with an embodiment of the present invention.

FIG. 8 is an illustration of a process performed in a pre-sales interface including edit/response/action that can be taken by the system upon failure of a validation, as a system in accordance with an embodiment of the present invention

FIG. 9 is an illustrative representation of a pre-sales interface cockpit, showing the standard.

FIG. 10 is pictorial illustration of a pre-sales interface cockpit, showing a standard interface.

### DETAILED DESCRIPTION OF THE INVENTION

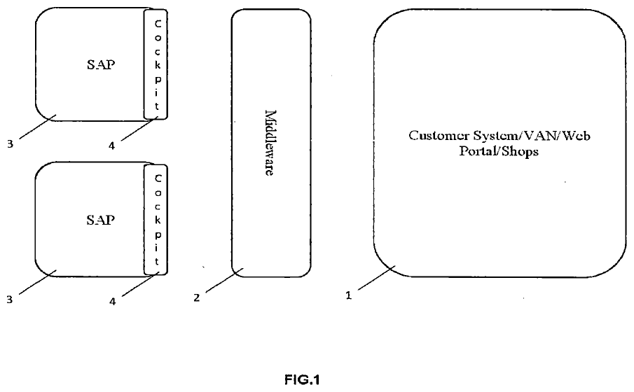

In the first embodiment according to FIG. 1 of the diagrams, it is illustrated a representation of a pre-sales interface cockpit, which show the flow of data from customer/legacy systems through to order creation, as a system diagram, in accordance with an embodiment of the present invention. 1 in the diagrams represents customer systems/VAN/Web Portal/shops, which may act as sources of data. 3 in the diagram represent legacy systems, which for the purposes of this disclosure shall be known simply as SAP. The legacy systems are coupled to a plurality of middleware 2, which may include from among other types of middleware at least in part of any of P/PO/Lobster/Webmethods/GXS-Opensource/Gentrains. Further in the diagram is a cockpit 4, which primarily provides for a novel operation of a plurality of SAP operably coupled to a plurality of middleware. In its essence, a plurality of middleware is operable between a pre-sales cockpit and a plurality of SAP, wherein a specific function in the Cockpit triggers the Standard SAP. The single pre-sales cockpit coupled to said SAP via said plurality of middleware is configured in that a plurality of sales orders can be created, processed and stored in the said SAP from the action of a single pre-sales cockpit, translating to an immense reduction of complexity for an operator of such SAP. The middleware 2 is capable of converting data input types including at least in part of Excel upload, PDF, EDIFACT, RFC, Proxy, CSV, XML, IDOC received from am action of the cockpit into an SAP standard.

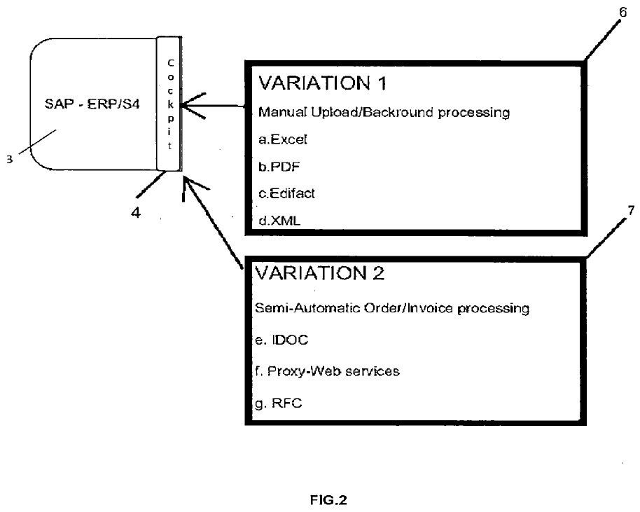

The embodiment according to FIG. 2 is an illustrative representation of the two variations of the cockpit's functionality. The variation 1 represents manual/background processing of files in different formats as described, while the variation 2 represents formats/protocols used by the cockpit to process the messages inside of the cockpit

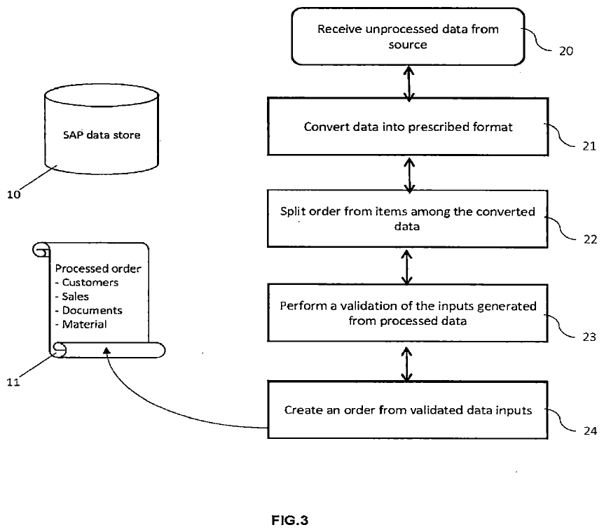

In another embodiment according to FIG. 3 is an illustrative representation of a process performed in a pre-sales interface cockpit, showing the steps from sales data input through to sales order creation, as a system diagram, in accordance with an embodiment of the present invention. An SAP data store 10 is provided where an order 11 processed through the said system is stored. In its essence, a processed order in the context of the current invention is comprised at least in part of a customer, a sales information, a document and supporting 30) material, which is retrievably stored in provided SAP data store. Te process of generating a processed order from a singular cockpit operably coupled to a plurality of middleware, which in turn is operably coupled to a plurality of SAP is comprised of a step 20, of receiving an unprocessed order data from a source, the step 21 of converting said data into a prescribed data format recognizable and attributable to a target SAP standard. Further, in the step 22 order items from converted data are split into individual items in preparation for a validation procedure. The subsequent step 23 entails performing a validation of the generated inputs from the processed data. The process performed by the cockpit defines what validations are performed and can be customised as per customer needs, for an error free order creation. It gives information on the specific non SAP standard sap tables created for the cockpit Business data storage, and the logic developed validates this data and throws errors. Also, the data conversions are taking place here in the background relating to customer, material, EAN codes, Unit of measures and quantities. The step 24 entails creating a sales order 11 for the SAP storage from among a plurality of SAP, and receiving a confirmation on a pre-sales cockpit.

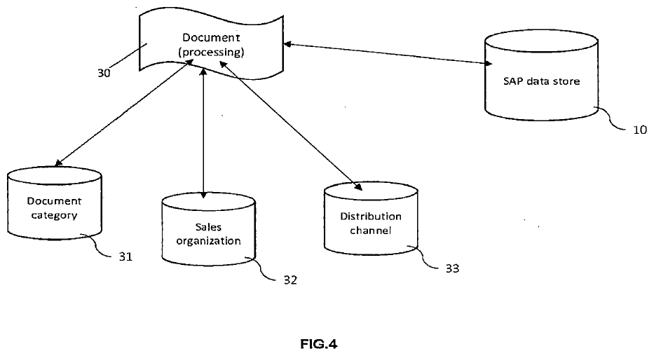

In another embodiment according to FIG. 4 is an illustrative representation of a process performed in a pre-sales interface cockpit, showing the levels at which sales order validation rules can be applied, as a system diagram, in accordance with embodiments of the present invention. The illustration shows the levels at which a sales order document 30 validation rules can be applied, as a chart diagram, in accordance with an embodiment of the present invention. The sales order validation rules can be applied at the levels of SD Document category 31, Sales Organization 32, Distribution Channel 33 and ultimately it is destined to the SAP data store 10 for storage. In their essence, the distribution channels can include wholesalers, retailers, distributors, and even the Internet. On the other hand, the sales organization is a department in company within logistics that designs the company as per the sales requirements. It is held responsible for the sales and distribution of goods and services. Finally, the selling unit is represented as a legal unit.

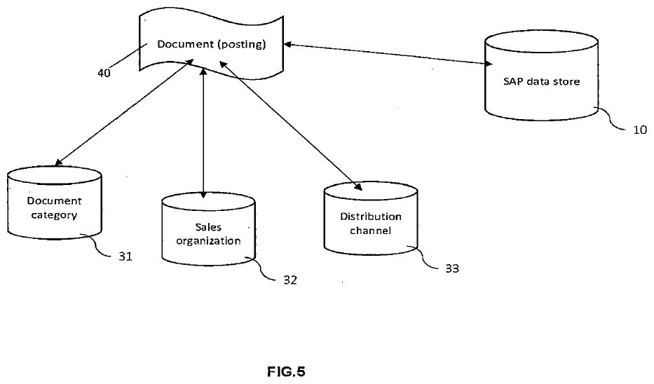

In a further embodiment according to FIG. 5 of the diagrams is an illustrative representation of a process performed in a pre-sales interface cockpit, showing the levels at which posting rules can be applied, as a system diagram, in accordance with an embodiment of the present invention. As with FIG. 2 of the diagrams, the posting document validation rules can be applied at the levels of Document category 31, Sales Organization 32, Distribution Channel 30) 33 and ultimately it is destined to the SAP data store 10 for storage. In their essence, the distribution channels can include wholesalers, retailers, distributors, and even the Internet. On the other hand, the sales organization is a department in company within logistics that designs the company as per the sales requirements. It is held responsible for the sales and distribution of goods and services. Finally, the selling unit is represented as a legal unit. The function of the cockpit in this regard is to abstract the complexities that would typically arise when trying to work with standard legacy systems to perform a similar task or tasks.

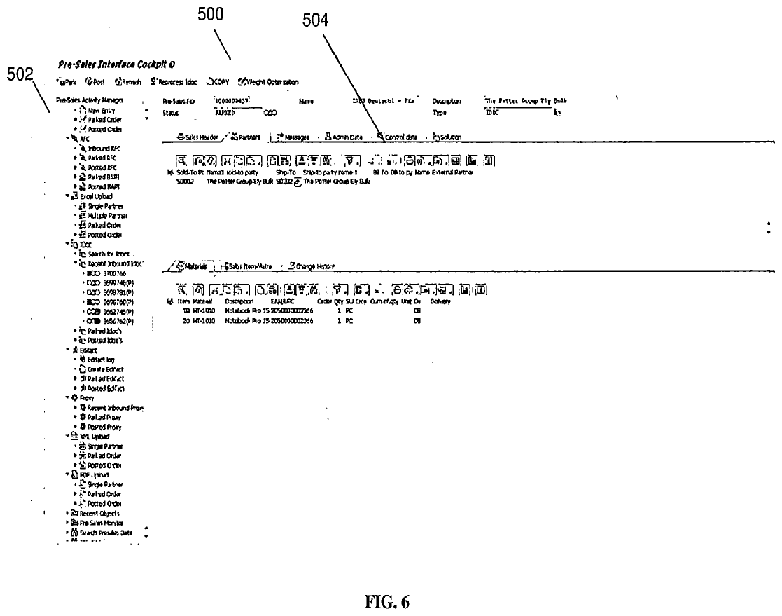

Subsequently in another embodiment according to FIG. 6 of the diagrams is an illustrative representation of a process performed in a pre-sales interface cockpit, including the pre-sales activity cockpit screen/interface 500, in accordance with an embodiment of the present invention. It is provided with a drop-down tree structure 502 on the left hand side providing for the performing of activities related to the processes of this invention.

The cockpit interface provides an input interface 504 capable of receiving inputs for a Purchase Order Data, Sales Data and and any such inputs as may be required to perform an order generation for the SAP as in FIG. 1 of the diagrams. Preferably, the provided functions include at least in part of a method to manually create a Quick Order Entry PRE_SALES, and Mass Order provided for multiple partners, a method to allow users to save an existing Sales Pre-Sales as a template, a method to allow users to create maps for orders in the form of Excel Files, wherein two map types are provided in accordance to the current invention: Single Partner (Sold-to) and Multiple Partner and a method to allow users to search for Pre-Sales by various fields such as material, customer, category among others. Furthermore, the functions include a method to allow users to run reports against Sales COCKPIT transactions, to perform a history log recording recently created PRE_SALES and user activities, a method for IDOCs navigation for monitoring, for monitoring of RFC messages and even further, a customer has the ability to specify proxies or web services. The provided features allow for various types of upload documents including: XML Upload, PDF upload, EDIFACT upload and Excel Upload among other as may be necessary and acceptably converted with the said cockpit and coupled middleware. The cockpit has the ability to perform error validation, create resolutions and infer type of data received, receive purchase order information and categorize the types of received orders, the status of orders and log changes performed by a user across all SAP all in one interface, which is a marked improvement upon all existing SAP.

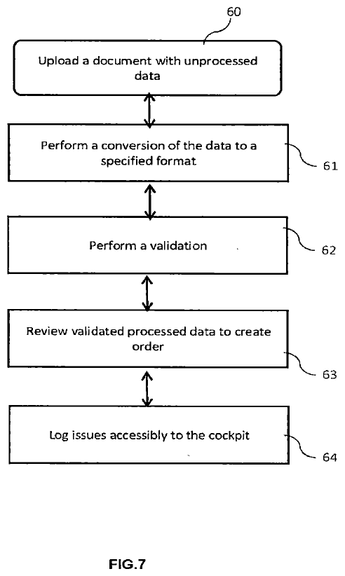

In another embodiment according to FIG. 7 of the diagrams is an illustrative representation of a process performed in a pre-sales interface cockpit, including the edit/response/action that can be taken by the system upon failure of a validation, as a system diagram, in accordance with an embodiment of the present invention. The process involves step 60 of uploading a document with unprocessed data enabled by a cockpit function, a step 61 of performing a conversion of the data to a specified format through a cockpit function that is operably coupled to a plurality of middleware, step 62 of performing a validation in any format as in FIG. 3 above, a step 63 of reviewing validated processed data to create order, and a final step 64 of logging issues accessibly to the cockpit, such logs and issues being attributable to a performing user.

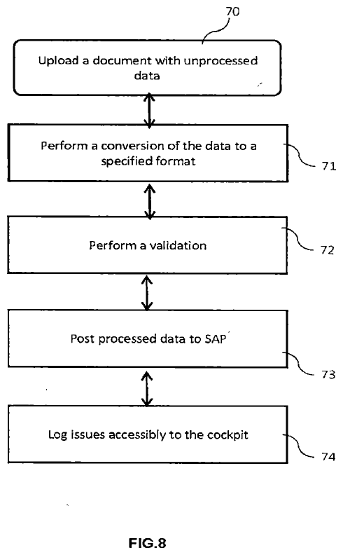

Further still, in another embodiment according to FIG. 8 of the diagrams is an illustrative representation of a process performed in a pre-sales interface cockpit, including the edit/response/action that can be taken by the system upon failure of a validation, as a system diagram, in accordance with an embodiment of the present invention. The process involves step 70 of uploading a document with unprocessed data enabled by a cockpit function, a step 71 of performing a conversion of the data to a specified format through a cockpit function that is operably coupled to a plurality of middleware, a step 72 of performing a validation in any format as in FIG. 3 above, s step 73 of posting processed data to SAP and a final step 74 of logging issues accessibly to the cockpit, such logs and issues being attributable to a performing user.

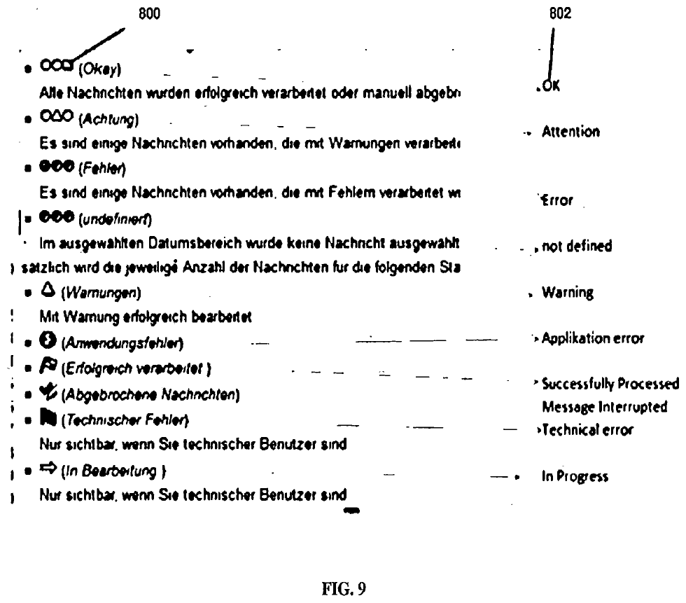

In an embodiment according to FIG. 9 is an illustrative representation of a pre-sales interface cockpit, showing the standard cockpit interface. Provided on the cockpit interface are functional elements served as icons, which allow the performing of the acts of this invention of providing an cockpit interface coupled to a plurality of middleware, in turn operably coupled to a plurality of SAP. As an example, the functional elements 800 of the diagram are used as a form of shorthand to give feedback such as ‘OK’ 802 or ‘warning’. Functional icons or elements and their corresponding meaning may further be provided as listed elements of a system diagram to teach a user how to use the invention. Preferably, sales orders can be created using input data such as EDIFACT, XML, Excel Upload, PDF upload, IDOC,RFC, Proxy, Mass Order Create, Quick Order Entry, or any other variations known in the art. The sales interface cockpit may be used by Sales Executives, Sales Managers, Sales Analysts, Sales Directors, Super users and end users, Supply Chain Managers, or any other variations known in the art, and is a unique tool for capturing sales orders in SAP.

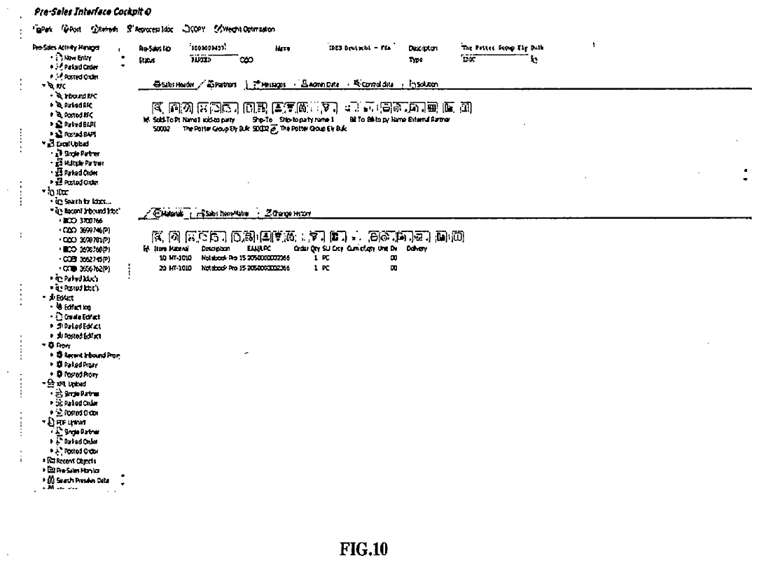

In a final embodiment according to FIG. 10 is a pictorial illustration of a pre-sales interface cockpit, showing a standard cockpit interface. The interface illustrates the main elements and modules provided for the functional implementation of the invention. On the main screen is illustrated an interface after sales orders are parked in the cockpit and successfully processed, while on the left of the interface are unctions available for a user.

### INDUSTRIAL APPLICATION

The current invention is applicable in the field of process management, especially in SAP and sales data management.

What is claimed is:

1. A system including a pre-sales cockpit comprising of:
a plurality of middleware operable between a pre-sales cockpit and a plurality of SAP;
a plurality of legacy SAP accessibly operable by a plurality of middleware, wherein said plurality of legacy SAP comprises at least in part of customer data and sales data, and;
a single pre-sales cockpit coupled to said SAP via said plurality of middleware in that a plurality of sales orders can be created, processed and stored in the said SAP at a single pre-sales cockpit.

2. The system as in claim 1, further comprising of a middleware capable of converting data input types including at least in part of Excel upload, PDF, EDIFACT, RFC, Proxy, CSV, XML, IDOC into an SAP standard

3. The system as in claim 1, further comprising of a functional configuration for loading sales orders.

4. The system as in claim 1, further comprising of a functional configuration for validation of uploaded document data.

5. The system as in claim 1, further comprising of a functional configuration for validation for SAP output from a middleware.

6. The system as in claim 1, further comprising of a functional configuration for loading aggregation of SAP outputs fetched by a respective middleware.

7. A method performed by a system including a pre-sales cockpit, the method comprising of:
receiving an unprocessed sales data from one of a plurality of SAP;
converting in a middleware said unprocessed data into a destination data format;
performing a validation against an established criterion on converted data;
creating a sales order in a storage among a plurality of SAP, and;
receiving a confirmation on a pre-sales cockpit.

8. The method as in claim 7, further comprising of performing a validation of an input at least in part in sales category, sales organization and distribution channel.

9. The method as in claim 7, further comprising of performing a rules-based posting of an input at least in part in sales category, sales organization and distribution channel.

10. The method as in claim 7, further comprising of performing an aggregation at a single interface of a plurality of SAP outputs.

11. The method as in claim 7, further comprising of performing an error correction to validate in an order creation, inputs including a delivery block, rejection of items in any order and posting to an SAP.

12. The method as in claim 7, further comprising of performing an error response upon failure of the middleware validation.
